(19) United States
(12) Patent Application Publication
(10) Pub. No.: US 2017/0050881 A1
(43) Pub. Date: Feb. 23, 2017

(54) WELDED GLASS PRODUCT AND METHOD OF FABRICATION

(71) Applicant: The University of Dundee, Dundee (GB)

(72) Inventor: Amin Abdolvand, Dundee (GB)

(73) Assignee: The University of Dundee, Dundee (GB)

(21) Appl. No.: 15/113,742

(22) PCT Filed: Jan. 27, 2015
(86) PCT No.: PCT/GB2015/000024

§ 371 Date: Jul. 22, 2016

(30) Foreign Application Priority Data
Jan. 28, 2014 (GB) GB14021421.1

(51) Int. Cl. C03C 27/08; C03C 23/00; C03C 21/00; B23K 26/082; B23K 26/324; B23K 26/18; B23K 26/00; B23K 26/57; C03B 23/203; C03B 25/02

(52) U.S. Cl. CPC C03C 27/08; C03B 23/203; C03C 23/0025; C03C 21/005; C03B 25/025; B23K 26/324; B23K 26/18; B23K 26/0063; B23K 26/57; B23K 26/082; B23K 2203/54

(57) ABSTRACT

A method for welding together glass workpieces where one of the workpieces has metal nanoparticles positioned at or near the surface to be welded. The method comprises positioning the workpieces in operative contact at an interface where a weld is to be formed, applying a laser beam to be incident upon the interface wherein energy from the laser beam is absorbed by the nanoparticle bearing workpiece and the energy from the laser beam is transferred to the glass surrounding the metal nanoparticles to heat the glass and to weld the workpieces together.

### INTRODUCTION

The present invention relates to a glass or ceramic product which is created by forming a weld between pieces of the material and a method of fabrication of the product.

### BACKGROUND

Welding is a fabrication process that joins materials by causing a portion of the materials which are to be joined to temporarily liquefy and coalesce. Subsequent cooling of the coalesced liquid causes the materials to be joined (fused) together. In traditional welding, a filler material is used in the making of the joint between metal pieces. In the context of the present patent application welding may be defined as involving either the presence or absence of a filler material.

Glass is an important material because of its excellent optical, mechanical, electrical and chemical properties. Unlike metals, which have a specific melting point, glasses have a melting range, called the glass transition. When heating the solid material into this range, it will generally become softer and more pliable. When it crosses through the glass transition, it will have the appearance of a very thick viscous liquid and welding can usually take place by simply pressing two melted surfaces together causing the two liquids to mix and join as one. Upon cooling through the glass transition, the welded piece will solidify as one solid piece of amorphous material.

There are many glass joining and bonding techniques which require an energy source to effect the fusion of glass pieces together to form a weld. A laser has many advantages because the laser beam may be transmitted through a transparent glass piece and “locally” heat an area of glass where the laser energy is to be absorbed. The use of laser energy for welding glass is important in the production of microelectronic devices, MEMS devices, microfluidic devices, sensors, and medical devices.

Techniques for direct joining of glass pieces using a focused femtosecond laser beam are known. The high intensity in the focal volume may induce nonlinear absorption and multiphoton absorption when femtosecond laser pulses are focused inside bulk transparent glass. The glass in the focal spot becomes opaque and absorbs laser energy leading to highly localized melting and joining of the glass.

Femtosecond laser pulses offer a variety of advantages over their nanosecond (ns) counterparts. Femtosecond lasers have a characteristic time scale that is far shorter than that of the atomic vibrations in the processed solid. Hence, while the material is being exposed to the laser radiation, energy transfer is not possible to the surrounding layers by means of phonon vibrations.

However, there are a number of disadvantages. One disadvantage is that femtosecond laser systems are expensive. The process also requires a lens objective of high numerical aperture, typically in the range of 0.4-0.65. This leads to a very short distance and shallow weld depth and ultimately restricts the welding efficiency (the process is slow). In addition, the surface quality of the glass work pieces must be very high, typically within λ/4. The above constitutes a serious challenge for adapting this technique by industry.

US2010/0186449 (Aitken) describes a method for creating a hermetically sealed glass package by bonding a clear glass layer to a substrate. It uses a continuous wave (CW) laser with a large average output power (25 W) to heat a glass substrate causing the substrate to swell. The swollen part forms a hermetic seal with the clear glass layer and bonds the substrate to the clear glass layer. US2010/0186449 describes three joining methods in which:
1. a sheet of glass substrate is welded directly to a sheet of transparent glass.
2. a bead of glass substrate is used to join two sheets of transparent glass.
3. a laminate of glass substrate and transparent glass is bonded to a second sheet of transparent glass.

The composition of the glass which forms the substrate is predetermined in order to enhance optical absorption of the glass in the near infra red region and in particular at 810 nm. The additive which enhances absorption is one or more transition metal oxide. US2010/0186449 provides no teaching on the distribution of the additive and indicates that the energy absorbed from the continuous wave laser provides bulk heating to the substrate.

### SUMMARY OF THE INVENTION

It is an object of the present invention to provide an improved apparatus for rapid and efficient welding together glass pieces.

In accordance with a first aspect of the invention there is provided a method for welding a first glass workpiece to a second glass workpiece, the method comprising the steps of:
positioning at least part of the first workpiece in operative contact with the second workpiece at an interface where a weld is to be formed;
applying a laser beam to be incident upon the interface;
wherein energy from the laser beam is absorbed by the second workpiece and
wherein the second workpiece comprises metal nanoparticles at or near the surface of the second workpiece, wherein the metal nanoparticles are integrally formed with the second workpiece and absorb the energy from the laser beam then transfer the absorbed energy to the glass surrounding the metal nanoparticles to heat the glass of the second workpiece and to weld it to the first workpiece.

The present invention provides a scalable and rapid technique for welding clear glass to glass with embedded metal nanoparticles.

Preferably, the metal nanoparticles are distributed substantially homogeneously across a layer or region of the second work piece.

Preferably, the layer or region is a predetermined depth below the interface.

Preferably, the metal nanoparticles directly absorb the energy from the laser beam then transfer the absorbed energy to the glass surrounding the metal nanoparticles to heat the glass of the second workpiece and to weld it to the first workpiece.

Preferably, the nanoparticles are arranged in a layer.

Preferably, the layer of nanoparticles has a thickness of between 500 nm and 50 μm.

More preferably, the layer of nanoparticles has a thickness of around (≧500 nm).

Preferably, the nanoparticles are positioned around 30 nanometres beneath the surface of the second workpiece.

Preferably, the transfer of absorbed energy from the metal nanoparticles to the glass causes an expansion of the nanoparticle containing layer which facilitates the weld between the first workpiece and the second workpiece.

Preferably, the nanoparticles have a diameter of between 20 and 60 nm.

Preferably, the nanoparticles are silver nanoparticles.

Preferably, the step of positioning the first and second work pieces in operative contact comprises applying a pressure to ensure operative contact between the first and second workpieces at the interface.

Preferably, the pressure acts to retain the first and second work pieces in a stationery position whilst a weld is being formed.

Preferably, the Interface comprises the region upon the second work piece upon which the laser beam is incident for the purpose of forming a weld.

Preferably, the first workpiece is substantially transparent to the laser beam.

Preferably, the laser beam is transmitted through the first work piece to the interface.

Preferably, the laser is a nanosecond pulsed laser.

Advantageously, the employed laser is an industrially adaptable source and the presented technique could find applications in sensor and medical device fabrication.

Preferably, the laser has a pulse length of between 1 ns and 100 ns.

Advantageously, nanosecond and femtosecond pulse lasers, provided a highly localised energy deposition into the material in which substantially all the laser power is absorbed by the thin embedded metallic nanoparticle layer. The nanoparticles absorb the laser energy due to their surface plasmon resonance absorption band and pass the heat to the surrounding glass which provides a very localised form of heating. Consequently, the formation of a large heat affected zone, is avoided.

Preferably, the laser has a repetition rate of between 20 kHz and 200 kHz.

Preferably, the laser has an average power of between 5 W and 15 W.

Preferably, the laser has a wavelength of 532 nm.

Preferably, the laser beam had a Gaussian intensity profile.

Preferably, the ratio of the beam parameter product (BPP) of an actual beam to that of an ideal Gaussian beam at the same wavelength is approximately ≦1.3 (M²).

Preferably, the laser beam focussed upon the interface has a flat surface.

Preferably, the flat surface is achieved using a flat field scanning lens system.

Preferably, the diameter of the focused spot on the interface between the points where the intensity of the spot has fallen to 1/e² of the central value is between 0.5 μm and 300 μm.

More preferably, said diameter is 60 μm.

Preferably, the laser operates with a mean laser fluence of from 0.05 to 3 J/cm².

More preferably, the laser operates with a mean laser fluence of from 0.1 to 1 J/cm².

Preferably, the second workpiece is created from a glass ion exchange product by annealing the ion exchange product at a temperature below the transition temperature of glass to create the layer of metal nanoparticles.

Preferably, the second workpiece is created from a glass ion exchange product by irradiating the ion exchange product with a laser.

Preferably, the ion exchange product may be selectively irradiated by the laser in order to create regions of metal nanoparticles on the surface of the workpiece where a weld may be created.

Preferably, the second workpiece is an ion exchange product.

Preferably, the method of the present invention comprises irradiating the ion exchange product with a first laser beam to create one or more regions of metal nanoparticles, then welding the second workpiece to the first workpiece using a second laser beam which is transmittable through the first work piece.

Preferably, the first laser beam has a wavelength of 355 nm.

Preferably, the second laser beam has a wavelength of 532 nm.

Optionally, the first glass workpiece comprises metal nanoparticles at or near the surface thereof.

Preferably, the metal nanoparticles are located at the interface where the weld is to be formed.

In accordance with a second aspect of the present invention there is provided a welded glass product made in accordance with the method of the present invention. In accordance with a third aspect of the present invention there is provided a glass product comprising a first workpiece in operative contact with a second workpiece at an interface and a weld joining the first workpiece to the second workpiece at the interface;

Wherein the second workpiece comprises metal nanoparticles at or near the surface of the second workpiece, wherein the metal nanoparticles are integrally formed with the second workpiece and absorb the energy from a laser beam then transfer the absorbed energy to the glass surrounding the metal nanoparticles to heat the glass of the second workpiece and to weld it to the first workpiece.

The present invention provides a scalable and rapid technique for welding clear glass to glass with embedded metal nanoparticles.

Preferably, the metal nanoparticles are distributed substantially homogeneously across a layer or region of the second work piece.

Preferably, the layer or region is a predetermined depth below the interface.

Preferably, the metal nanoparticles directly absorb the energy from the laser beam then transfer the absorbed energy to the glass surrounding the metal nanoparticles to heat the glass of the second workpiece and to weld it to the first workpiece.

Preferably, the nanoparticles are arranged in a layer.

Preferably, the layer of nanoparticles has a thickness of between 500 nm and 50 μm.

More preferably, the layer of nanoparticles has a thickness of around (≧500 nm).

Preferably, the nanoparticles are positioned around 30 nanometres beneath the surface of the second workpiece.

Preferably, the transfer of absorbed energy from the metal nanoparticles to the glass causes an expansion of the nanoparticle containing layer which facilitates the weld between the first workpiece and the second workpiece.

Preferably, the nanoparticles have a diameter of between 20 and 60 nm.

Preferably, the nanoparticles are silver nanoparticles.

Preferably, the step of positioning the first and second work pieces in operative contact comprises applying a pressure to ensure operative contact between the first and second workpieces at the interface.

Preferably, the pressure acts to retain the first and second work pieces in a stationery position whilst a weld is being formed.

Preferably, the Interface comprises the region upon the second work piece upon which the laser beam is incident for the purpose of forming a weld.

Preferably, the first workpiece is substantially transparent to the laser beam.

Preferably, the second workpiece is created from a glass ion exchange product by annealing the ion exchange product at a temperature below the transition temperature of glass to create the layer of metal nanoparticles.

Preferably, the second workpiece is created from a glass ion exchange product by irradiating the ion exchange product with a laser.

Preferably, the ion exchange product may be selectively irradiated by the laser in order to create regions of metal nanoparticles on the surface of the workpiece where a weld may be created.

Preferably, the second workpiece is an ion exchange product.

Preferably, the method of the present invention comprises irradiating the ion exchange product with a first laser beam to create one or more regions of metal nanoparticles, then welding the second workpiece to the first workpiece using a second laser beam.

Preferably, the first laser beam has a wavelength of 355 nm.

Preferably, the second laser beam has a wavelength of 532 nm.

Optionally, the first glass workpiece comprises metal nanoparticles at or near the surface thereof.

Preferably, the metal nanoparticles are located at the interface where the weld is to be formed.

### BRIEF DESCRIPTION OF THE DRAWINGS

The present invention will now be described by way of example only, with reference to the accompanying drawings in which:

FIG. 1 is a schematic diagram which shows the process for creating a weld in accordance with an embodiment of the present invention;

FIG. 2 is a graph which shows the transmittance spectra of an example of a first workpiece (B270 glass-dotted line) and a second workpiece doped with a layer of silver nanoparticles embedded (continuous line);

FIG. 3a is an image of a welded sample, FIGS. 3b to 3d are magnified images of the welded sample;

FIG. 4a is a magnified image of a second workpiece sample which has been irradiated with a laser having fluence of about 0.15 J/cm², FIG. 4b shows a magnified image of a second workpiece sample and a first workpiece sample which have been irradiated with a laser having fluence of about 0.14 J/cm² and FIG. 4c is an image which shows glass particles on cover glass;

FIGS. 5(i). 5(ii) and 5(iii) are schematic diagrams which illustrate the welding process as achieved using a method in accordance with the present invention;

FIG. 6a shows circular-shaped multi-line joining contour with an outer diameter of 6 mm, the inset shows the joining seams and FIG. 6b shows a cross-section of a multi-line joint with the seams indicated by white arrows; and

FIG. 7 shows a simulated optical and temperature field distributions for a 2-D regular array of silver nanoparticles, with periodic spacing of (a) 200 nm and (b) 5 nm.

### DETAILED DESCRIPTION OF THE DRAWINGS

The present invention provides a scalable, rapid and crack-free welding of glass with embedded metallic nanoparticles to clear glass upon nanosecond or picosecond pulsed laser irradiation at room temperature. The employed laser is an industrially adaptable source and the presented technique could find applications in sensor and medical device fabrication.

In a preferred embodiment, the second workpiece is used as a substrate to which a clear glass piece may be welded and comprises a layer of silver nanoparticles.

There are a number of ways in which the second workpiece may be created.

In one embodiment Ag⁺Na⁺ ion exchange is used to create a piece of glass which is called the ion exchange product. The ion exchange can be formed either by placing the glass in a mixed melt of AgNO₃/KNO₃ or by application DC electric field across the glass sample.

The layer of spherical silver nanoparticles is formed by annealing the ion exchange product inside an oven below the transition temperature of glass (400-550° C.). The annealing can be done either in H₂ reduction atmosphere or in air atmosphere. This depends on which way the ion exchange products was fabricated. Another method comprises using a laser to selectively heat areas of the ion exchange product where nanoparticles are required.

In this example of the present invention, the position of the nanoparticles is largely determined by the position of the sodium ions in the amorphous glass which are exchanged for metal ions in the ion exchange process. In that sense, the metal ions (typically silver) can be said to be randomly distributed because the original location of the sodium ions has not been predetermined. The distribution of the nanoparticles may be sufficiently homogeneous to allow their presence to create enhanced localised heating for the creation of a weld between two work pieces when laser energy is applied.

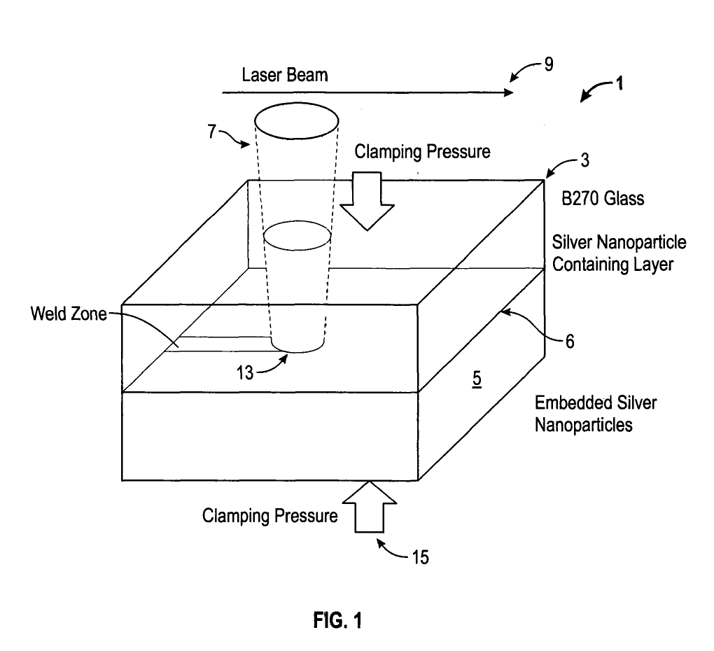

FIG. 1 is a schematic diagram 1 of an apparatus for welding glass in accordance with the present invention. A first workpiece 3 is shown which comprises a 1 mm thick Schott B270 glass clamped 15 to a second workpiece 5 which comprises a soda-lime glass with a layer of silver nanoparticles 6 at or near the surface of the second workpiece 5 adjacent to the first workpiece 3. A laser beam 7 is shown being transmitted through the first workpiece 3 and being incident upon an area 13 of the surface of the second workpiece 5 where the layer of silver nanoparticles is present.

In this example of the present invention, the first workpiece 3 comprises a commercial Schott B270 white glass (composition in wt %: (69.2) SiO₂, (9.8) Na₂O, (9.5) CaO, (7.6) K₂O, (2.8) BaO, (1.1) Al₂O₃) with a thickness of 1 mm. The second workpiece 5 comprises a silver-doped nanocomposite (SDN) glass. This was prepared from a 1 mm thick soda-lime float glass (comprising in wt.-%: 72.5 SiO₂, 14.4 Na₂O, 6.1 CaO, 0.7 K₂O, 4.0 MgO, 1.5 Al₂O₃, 0.1 Fe₂O₃, 0.1 MnO, 0.4 SO₃) by Ag⁺—Na⁺ ion exchange and subsequent annealing at 400° C. in H₂ reduction atmosphere. This resulted in the formation of spherical silver nanoparticles of 30-40 nm mean diameter in a thin surface layer of ˜20 μm. The nanoparticle-containing layers were formed ˜30 nm beneath the surface of the glass.

Rapid welding of the second workpiece 5 to the first workpiece 3 was achieved using nanosecond pulsed laser irradiation at 532 nm at a mean laser fluence of ˜0.15 J/cm². The laser energy was absorbed by the nanoparticles and the heat transferred to the surrounding glass leading to local bubble formation, melting, vaporization and the formation of a strong weld.

In this embodiment of the present invention a Nd:YVO₄ laser with a maximum average power of 10 W at λ=532 nm, pulse length of τ=38 ns and repetition rate of f=100 kHz was utilized for irradiation of the workpieces at room temperature.

The laser beam had a Gaussian intensity profile (M²˜1.1) and was focused onto the joining target surfaces (between the pieces) using a flat field scanning lens system, a specialized lens system in which the focal plane of the deflected laser beam is a flat surface.

Flat field scanning lens systems are commonly used in laser processing applications to offset the off axis deflection of the beam through the focusing lens system. The diameter of the focused spot between the points where the intensity has fallen to 1/e² of the central value was 60 μm. This resulted in a Rayleigh range of ˜4.9 mm. This large Rayleigh range results in a negligible change of the beam spot size on the joining area, providing a uniform ablation trace throughout the experiments. The laser beam was raster scanned over the surface of the target at a velocity of V=10 mm/s, using a computer-controlled scanner system. The characterizations were performed using a JASCO V-670 UVNIS/NIR spectrophotometer and KEYENCE 1.0 Digital Microscope VHX-1000.

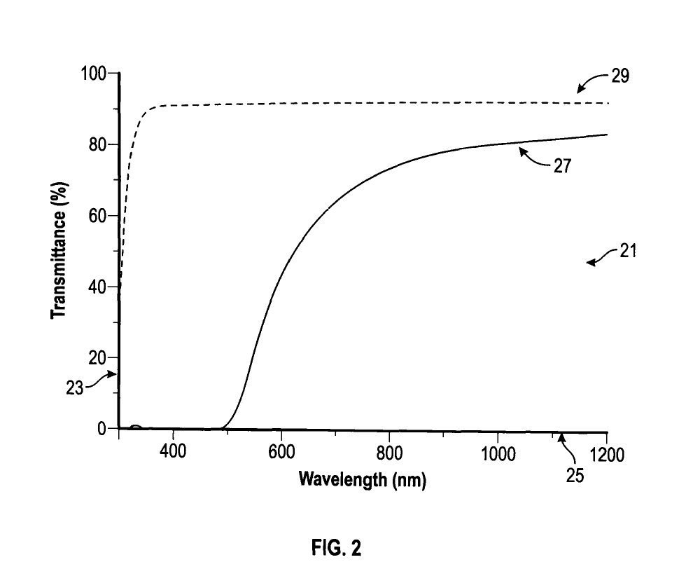

FIG. 2 is a graph 21 which plots transmittance 23 against wavelength 25 and it shows the transmission spectra of the clear glass 29 and glass with embedded silver nanoparticles 27. According to the transmittance spectra, the laser energy was reduced by approximately 10% by the first workpiece due to the small absorption and the lack of antireflection coating. The silver particles layers in the SDN glass are on both sides, inducing large absorption centred around 430 nm.

The following simple thermal conduction model for the process has been created and is in agreement with experimental observations. According to the model, the expansion of a nanoparticle containing layer or region facilitates the creation of a weld.

The volume filling factor of the nanoparticle containing layer in SDN glass has an exponential profile with the maximum just beneath the surface of the sample.

Assuming that the absorption coefficient also has an exponential distribution and it reduces to e⁻² (13.5%) within 15 to 20 μm depth. An exponential function model for the absorption distribution coefficient in SDN glass, given by:

$$α ( z ) = {α}_{0} exp ( - \frac{2}{l} \cdot z ) \qquad ( 1 )$$

In Eq. (1), α₀ is the max absorption coefficient on the surface and l is 0.0015 cm. According to the Beer-Lambert law, the pure transmittance (T) in single silver nanoparticles layer may be calculated by:

$$T ( z ) = \frac{I ( z )}{{I}_{0}} = exp ( \frac{{α}_{0} \cdot l}{2} \cdot ( exp ( - \frac{2 z}{l} ) - 1 ) ) \qquad ( 2 )$$

When z>>l, the T will be reduced to a constant.

T(z)→T=exp(−α₀·l/2) (3)

The total transmittance (T_{D}) and total reflection (Rₘ) of the 1 mm SDN glass are measured by JASCO V-670 Spectrophotometer, and have the relations with T and pure reflection of Glass with nanoparticles glass surface (R) in Eq. (4) and Eq. (5).

$$\begin{matrix}{T}_{D} = ( 1 - R ) \times T \times T \times ( 1 - R ) & ( 4 ) \\ {R}_{m} \approx R + R \cdot {( 1 - R )}^{2} \cdot {T}^{4} = R + \vert \frac{R}{{( 1 - R )}^{2}} \cdot {T}_{D}^{2} & ( 5 ) \\ {α}_{0} = \frac{2}{l} \cdot [ ln ( 1 - R ) - \frac{1}{2} ln ( {T}_{D} ) ] & ( 6 )\end{matrix}$$

The max absorption coefficient α₀ of Glass with nanoparticles glass at 355 nm/532 nm/1064 nm are in Table. (1) and calculated by Eq. (6):

TABLE 1
Absorption coefficient in Ag nanoparticles layer
of Glass with nanoparticles glass

| | 355 nm | 532 nm | 1064 nm |
|---|---|---|---|
| T_{D} | 0.00017 | 0.1354 | 0.8106 |
| Rₘ | 0.0609 | 0.07273 | 0.11 |
| R | 0.0609 | 0.071 | 0.063 |
| α₀,/cm | 5702^{a} | 1234.82 | 53.2 |

^{a}The absorption of glass is ignored.

The 532 nm laser is used to weld glass because of suitable absorption coefficient in the Ag particles layer. The laser parameters of best welding results (welded and no cracks) is: mean fluence (attenuated by ˜1 mm B270 glass) is 0.14 J/cm2, frequency is 100 kHz, scanning speed is ˜10 mm/s. So, the pulses per spot are 600 pulses/spot.

The pulse length τ (FWHM) is 38 ns.

The fluence at central area (F₀) will be double because of Gaussian distribution, and the fluence distribution function is:

$$F ( x , y ) = {F}_{0} \cdot exp ( - \frac{2 {x}^{2}}{{ω}_{0}^{2}} - \frac{2 {y}^{2}}{{ω}_{0}^{2}} ) \qquad ( 7 )$$

The ω₀ is laser beam waist. We assume that Glass with nanoparticles has the same thermal parameters as B270 glass: the density (p) is 2.55 g/cm³, specific heat capacity (cₚ) is 0.86 J/g·K, thermal conductivity (k) is 1.0 W/m·K and they are all constants at 20° C.-100° C. The thermal diffusivity coefficient (D) is 0.46×10⁻⁶ m²/s and the thermal diffusivity length (L) during full pulse length (2τ) is 3.7×10⁻⁷ m. They are given by Eq. (8):

$$L \approx 2 \sqrt{D 2 τ} , D = \frac{k}{ρ \cdot {c}_{p}} \qquad ( 8 )$$

We assume the heat is kept in original position and the temperature is proportional to absorbed laser fluence because the L is very small (L<<l<<2ω₀). The temperature distribution may calculated by laser fluence and absorption distribution after a laser pulse.

$$Δ T ( x , y , z ) = \frac{{α}_{0} exp ( - 2 z / l )}{ρ \cdot {c}_{p}} ( 1 - R ) F ( x , y ) {e}^{\frac{{α}_{0} l}{2} ( exp ( - 2 z / l ) - 1 )} \qquad ( 9 )$$

The max temperature is at the central area (x=0, y=0, z=0) of spot on glass with nanoparticles surface. The result is about 146 Kelvin increase after one laser pulse irradiation. So, most of laser energy will be deposited in the top Ag nanoparticles composition layer. The top of this layer will absorb more energy than the bottom because of more particles concentration and more laser energy. The heating mechanism is different from a metal sample. The localized heat accumulation effect should be considered in glass sample because of low thermal conductivity.

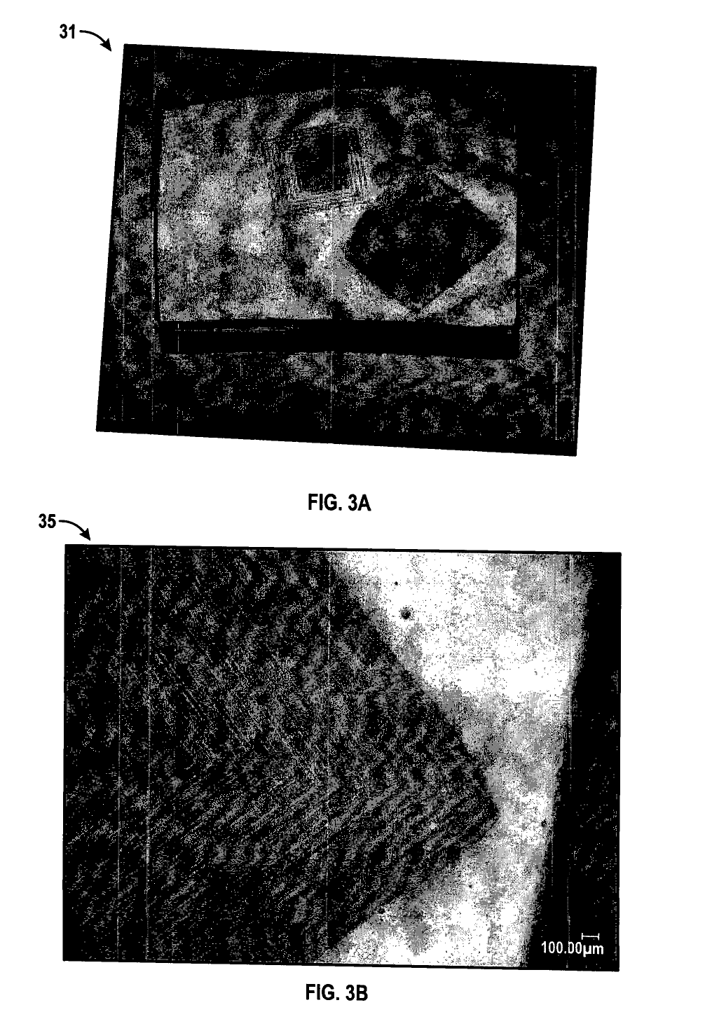

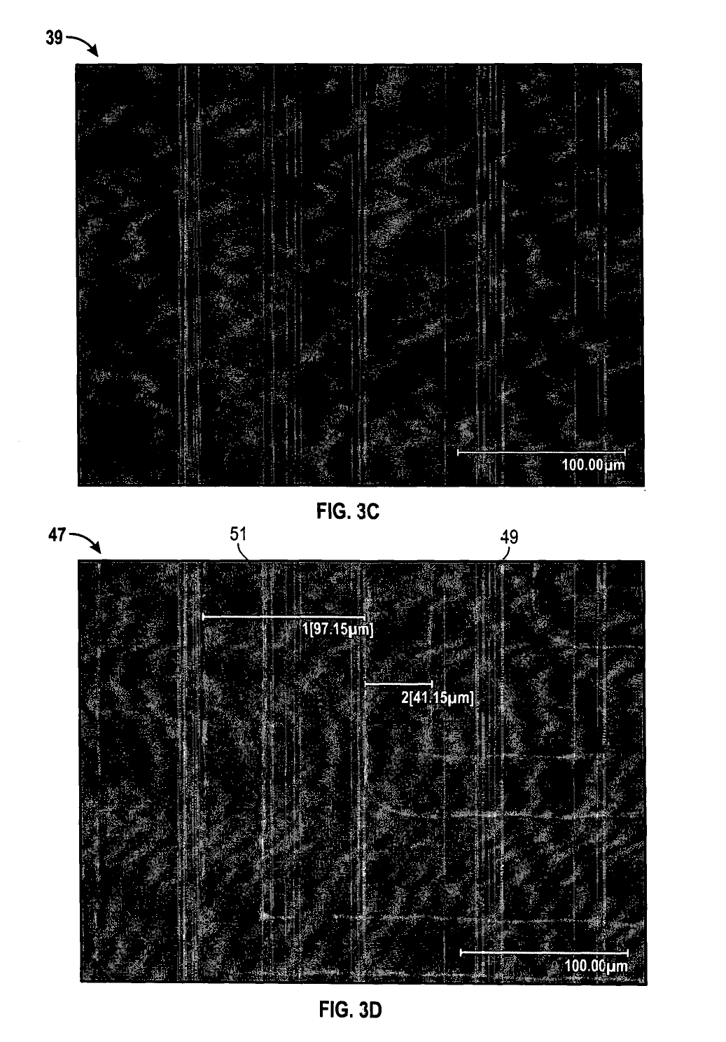

FIG. 3 is an image 35 of a welded sample. The welded areas have changed colour and are opaque in FIGS. 3 (c) and (d). FIG. 3d also shows the width 49 of a weld 47 as being 41.15 μm and the weld width and distance between welds 51 as being 97.15 μm.

In order to demonstrate the welding mechanism, control experiments were undertaken with the same laser parameters but with the cover glass removed. The fluence is slightly greater than welding fluence because of no cover glass.

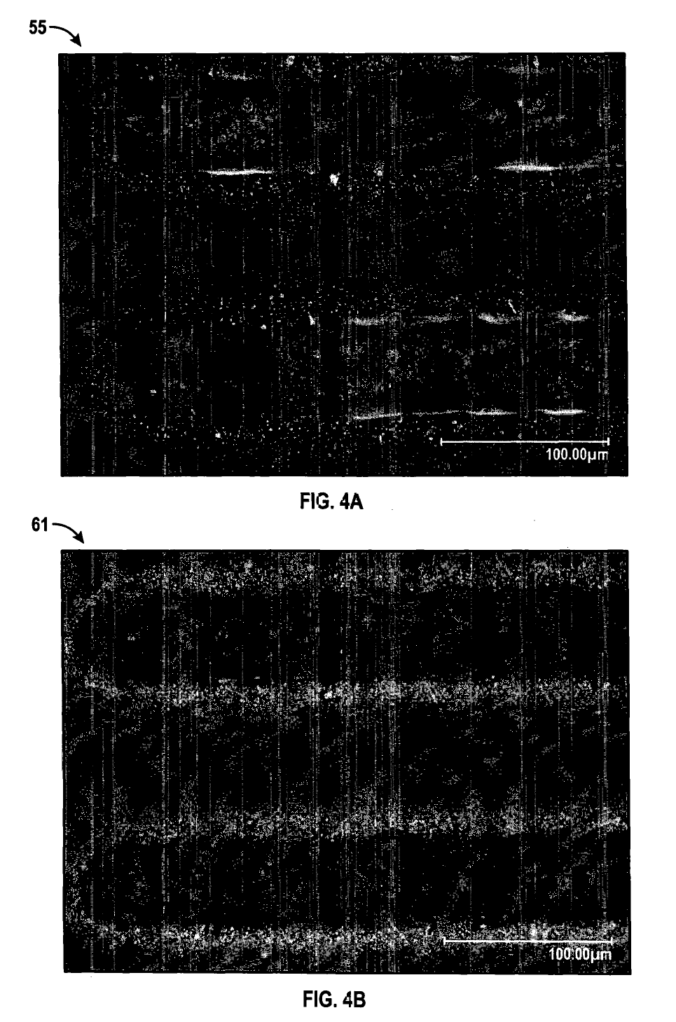

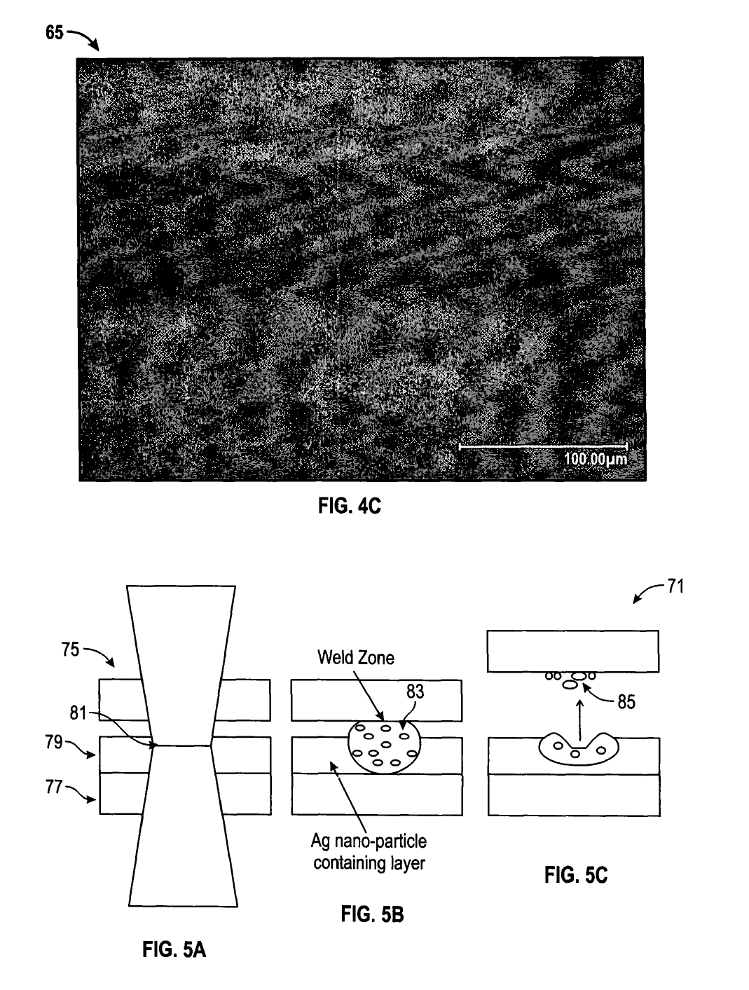

FIG. 4 (a) is an image 55 showing the irradiation result of glass containing nanoparticles glass using about 0.15 J/cm² fluence with no cover glass. It shows that there are lots of bubbles under the notch bottom. FIG. 4 (b) shows the irradiation of glass with nanoparticles using the dame fluence as in FIG. 4a but with a ˜1 mm cover glass. The cover glass is on the top of glass with nanoparticles glass but the gap is ˜0.2 mm. The attenuated fluence is about 0.14 J/cm² therefore, the fluence is same as the fluence in welding experiment. The bubbles are under the notch bottom. There are lots of glass particles beside the irradiation area. There are glass particles on the cover glass too. FIG. 4x shows glass particles on the cover glass.

FIGS. 5(i), 5(ii) and 5(iii) are schematic diagrams 71 which illustrate the proposed welding mechanism in accordance with the present invention. FIG. 5(i) shows a laser beam 73 transmitted through a first work piece 75 and absorbed by metal nanoparticles in a layer 79 of the second workpiece 77. FIG. 5(ii) shows the weld zone 81 where bubbles are created from the layer material and in FIG. 5(iii) the layer material is shown in contact 85 with the first workpiece 75.

In this embodiment of the invention, the clear glass samples were commercial Schott B270 white as described with reference to the first embodiment of the invention and with thicknesses of ˜1 mm and ˜4 mm. The Metal Glass Nanocomposite (MGN) wafers were fabricated from a 1 mm thick soda-lime float glass as before and having a transition temperature in the range from 550 to 580° C.

This resulted in the formation of randomly distributed spherical silver nanoparticles of =30-40 nm mean diameter in a thin surface layer of ≈10 lm on both sides of the glass substrate. The nanoparticle-containing layers were formed ≈30 nm beneath the surface of the glass. Single-sided samples were used in our experiments and were made by removing a ≈20 μm thick layer from one side of the MGN by etching in 12% HF acid. The surface plasmon resonance band is peaked at ≈430 nm. The optical transmittance of a single-sided MGN wafer is ≈63% at 532 nm.

The laser joining of the ˜15 mm×˜12 mm clear glass samples and MGN was performed by utilizing a Nd:YVO₄ laser as described above with respect to the first embodiment using a similar experimental setup as shown in FIG. 1b.

The laser beam had a Gaussian intensity profile (M²<1.3) and was focused onto the interface between the transparent glass samples and MGN wafers using a flat-field scanning lens system (F-theta lens) with a focal length of ˜160 mm. The diameter of the focused spot was =60 μm at the 1/e² level.

The samples were irradiated at different scanning speeds (v) with the number of pulses fired per spot (N) varying from 5 to 3000, and laser fluences (F) ranging from 0.03 to 0.70 J/cm², taking into account the Fresnel loss at the top transparent glass wafer. A fairly moderate pressure was applied in order to bring the clear glass and MGN wafers in close proximity for laser irradiation. The air gap, estimated from the interference pattern observed after mounting the samples in a mechanical fixture, was ≈1150 nm. The samples for laser joining were used as received without any additional polishing of the surfaces.

Before laser processing, surfaces were cleaned with acetone, propanol then rinsed with deionised water, and dried with a nitrogen gun. The samples were characterised using a spectrophotometer (JASCO V-670) and a Digital Microscope (KEYENCE VHX-1000).

A single line laser irradiation was conducted in order to determine the optimal bonding conditions. At energy fluences below 0.10 J/cm² (at fixed v=˜10 mm/s), the interfacial bonding strength was insufficient to hold the wafers together. For the laser fluences exceeding values of 0.21 J/cm², formation of cracks originating at the MGN surface was observed.

Using a number of pulses per spot of less than 120 (at fixed F=0.13 J/cm²) led to a significant reduction in the bonding strength, whilst generation of cracks was observed above N=1500.

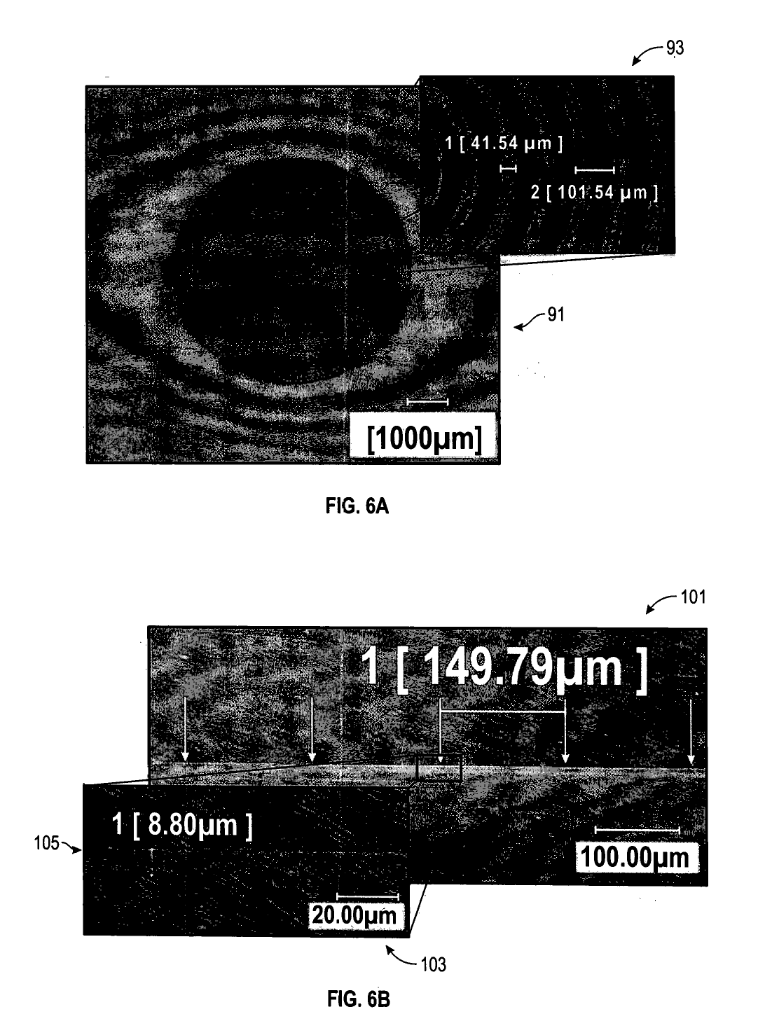

An example of multi-line laser joining is shown in FIG. 6a. A circular-shaped joining contour 91 with an outer diameter of 6 mm and a distance between consecutive scans (T) of 100 μm was achieved at F=0.13 J/cm² and v=˜10 mm/s leading to a set of continuous joining seams of ≈42 μm width as shown in the inset 93 of FIG. 6a. No crack formation or heat affected zone were observed. The joint strength was measured to be ≈12.5 MPa. The samples separated as a result of the test demonstrated brittle fracture, which verifies the fused joint.

A cross section 101 of multi-line laser joining is presented in FIG. 6b. The joining seam morphology in the inset of FIG. 6b reveals that the nanoparticle-containing layer 105 facilitates localized deposition of the laser energy and reduces the energy density levels required for laser joining. The seams are indicated by white arrows and the silver nanoparticle containing layer of 8.8 μm is clearly resolved The heat affected zone is negligible and is confined to the very interfacial layer in the contact zone. This confirms a low thermal load exerted on the joined components. Furthermore, the multi-line surface plasmon resonance assisted laser joining was applied to hermetically seal a ˜4 mm×˜4 mm region.

In order to understand the joining mechanism, thermal modelling was performed. The model first calculated the optical near-field intensity distributions of the composite system using a 3-D full EM solver. The results were then fed into a transient thermal model, as a heating source, to identify the temperature field evolution of the system. Particular attention was paid to the interfacial regions where the micro-welding process took place.

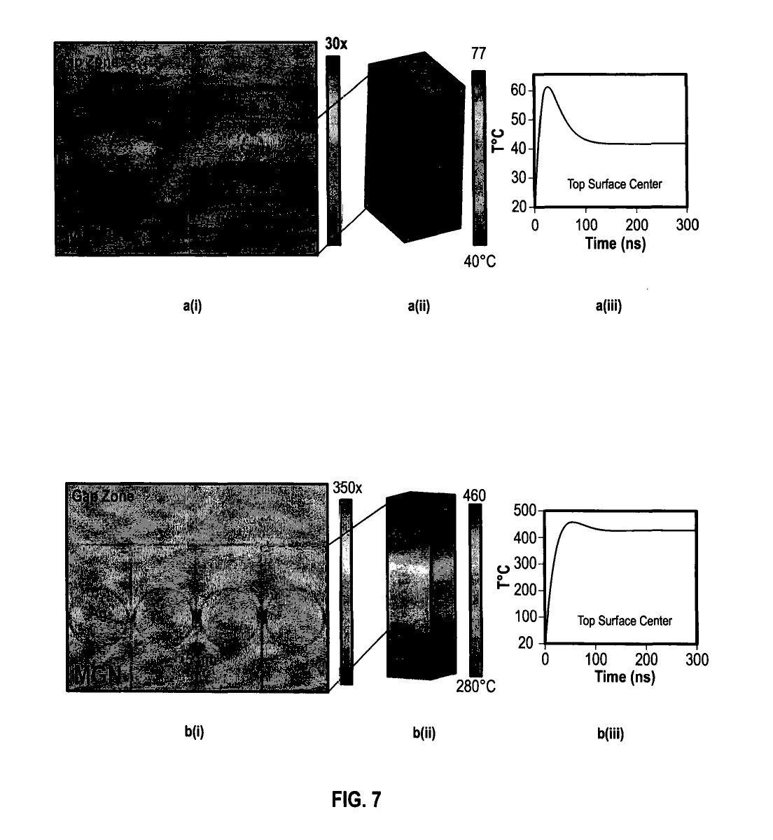

FIG. 7 shows two sets of diagrams which illustrate the simulated optical and temperature field distributions for two extreme representative particle spacing configurations. FIG. 7a(i) illustrates the spatial arrangement of particles. FIG. 7a(ii) a temperature profile and FIG. 7a(iii) a graph of temperature v time for a 2-D regular array with neighbour particle spacing of 200 nm.

FIG. 7b(i) illustrates the spatial arrangement of particles, FIG. 7b(ii) a temperature profile and FIG. 7b(iii) a graph of temperature v time for shows a 2-D regular array with neighbour particle spacing of 5 nm. The laser parameters for the modelling strictly followed the experiments: laser fluence=0.13 J/cm², pulse duration=38 ns, glass refractive index n_{g}=1.5, and silver refractive index n_{Ag}=0.13+3.1i. These results demonstrate that the strong near-field coupling of the multiple silver nanoparticles lead to a significant amplification of the optical fields inside the MGN substrate.

For example, at the spacing of 5 nm the field was enhanced by a factor of 350. Such strong field enhancement effect has already found applications in, e.g., surface enhancement Raman Scattering and biomedical sensing. In the present case, these highly localized near-fields serve as highly efficient local heating sources inside the substrate. Given that the MGN wafer contains randomly distributed silver nanoparticles in its doped region and although the nanoparticles are all 30-40 nm in diameter, the particles' spacings are not fixed and vary within a range, typically from few nanometers to 200 nm as estimated from the volume filling factor of the MGN sample.

Part of the delivered laser energy is absorbed and scattered by the nanoparticles while the rest is dissipated into heat. There will be a large number of nanoscale heating sources within each laser spot since multiple nanoparticles are illuminated and heated simultaneously. These heated particles will undergo a complex thermal exchange rebalance process, through conduction, and are responsible for the bonding effects that we observed in the experiments. The temperature range of the MGN sample under laser heating (at fluence 0.13 J/cm2) is of the order of 60-70° C. for loosely neighboured nanoparticles and about 400-500° C. for closely positioned particles. Further calculations on the time history of the temperature fields (for the 200 nm-spacing sample) reveal that the heat accumulation effect does indeed exist in our process: at 10 μs (corresponding to the laser repetition rate of f=100 kHz) during the time when the second laser pulse arrives, the MGN surface temperature does not drop back to room temperature (20° C.) but remains at about 36° C. For complete cooling, it takes about 38 μs, roughly a factor of 10³ longer than the laser pulse duration of τ=38 ns.

Thus, the heat accumulation effect is indeed essential for building up a sufficient level of thermal energy that melts the two joining glass surfaces. Hence, in order to build up the temperature fields for melting and thus welding (>570° C.), multiple pulses are required. This is in agreement with our experimental observations where about N=600 pulses were required for achieving a good quality joint. The melting is relatively gentle in our process leading to a strong joint with excellent quality.

In another embodiment of the present invention, the second workpiece is created from a glass ion exchange product by using a laser beam. Advantageously, the laser beam may be used to create regions of metal nanoparticles on the surface of the workpiece where a weld may be created and the remainder of the surface will remain as an ion exchange product. It is noted that the ion exchange product may have a lower coefficient of absorption than the regions in the second workpiece where metal nanoparticles have been created.

In this example, a first laser beam with a wavelength of 355 nm is used to create one or more regions of metal nanoparticles and a second laser beam has a wavelength of 532 nm creates the weld between the first workpiece and the second workpiece. In another embodiment of the invention, an ion exchange product is positioned beside the transparent glass and is welded directly to it. In this embodiment a higher power, more intense laser (roughly double or more), would be needed in order to create the particles and then create the weld.

In the preferred embodiment of the present invention an Ag nanoparticle composition layer was created in order to absorb energy from a nanosecond laser source in order to weld together a first workpiece and a second workpiece. Because the laser energy is mainly absorbed in the Ag nanoparticle layer, the glass beside the nanoparticles is heated and expands.

The central area of spot where the laser is focussed experiences a higher laser fluence and temperature increases of around 140° C. after one pulse irradiation. The heat is accumulated in glass after many pulses and glass vapour in bubble pushes the melted glass out from surface to touch the first workpiece.

The present invention may be used in various micro-packages applications, such as microfluidic devices, microelectronic devices and MEMS devices.

It is further noted that the present invention uses a substrate which is a glass containing a layer or region of embedded metal doped nanoparticles which have significantly different physical properties than a metal oxide additive such as that disclosed in US2010/0186449. In particular, the present invention provides a thin layer of embedded nanoparticles below the glass surface the layer being formed from clusters of metal atoms. The use of a laser provides a highly localised heating effect at the nanoparticles which improves weld quality and reduces damage to the surrounding glass. US2010/0186449 merely discloses the use of additional transition metal oxides to improve the absorption of heat from an infrared laser in the bulk glass.

The thermal conduction model described in relation to the present invention, which agrees with experimental data, is based upon the creation of a homogeneous layer or region and where the nanoparticles are present within the glass.

US2010/0186449 makes no reference to the position of the transition metal oxide particles as being of particular relevance and certainly does not describe them as being layered or concentrated in a specific part of the glass.

While in comparison to the femtosecond pulses lasers, the CW laser sources are cheaper and the welding process is much faster, CW sources do not provided a highly localised energy deposition into the material and hence result in the formation of a large heat affected zone. Pulsed laser sources (nanosecond, picosecond or femtosecond), provided a highly localised energy deposition into the material in which substantially all the laser power is absorbed by the thin embedded metallic nanoparticle layer. The nanoparticles absorb the laser energy due to their surface plasmon resonance absorption band and pass the heat to the surrounding glass which provides a very localised form of heating.

Improvements and modifications may be incorporated herein without deviating from the scope of the invention.

1. A method for welding a first glass workpiece to a second glass workpiece, the method comprising the steps of:
positioning at least part of the first workpiece in operative contact with the second workpiece at an interface where a weld is to be formed;
applying a laser beam to be incident upon the interface;
wherein energy from the laser beam is absorbed by the second workpiece and wherein the second workpiece comprises metal nanoparticles at or near the surface of the second workpiece, wherein the metal nanoparticles are integrally formed with the second workpiece and absorb the energy from the laser beam then transfer the absorbed energy to the glass surrounding the metal nanoparticles to heat the glass of the second workpiece and to weld it to the first workpiece.

2. A method as claimed in claim 1 wherein, the metal nanoparticles are distributed substantially homogeneously across a layer or region of the second work piece.

3. A method as claimed in claim 2 wherein, the layer or region is a predetermined depth below the interface.

4. A method as claimed in claim 1 wherein, the metal nanoparticles directly absorb the energy from the laser beam then transfer the absorbed energy to the glass surrounding the metal nanoparticles to heat the glass of the second workpiece and to weld it to the first workpiece.

5. A method as claimed in claim 2 wherein, the layer of nanoparticles has a thickness of between 500 nm and 50 μm.

6. (canceled)

7. A method as claimed in claim 3 wherein, the nanoparticles are positioned around 30 nanometres beneath the surface of the second workpiece.

8. A method as claimed in claim 1 wherein, the transfer of absorbed energy from the metal nanoparticles to the glass causes an expansion of the nanoparticle containing layer which facilitates the weld between the first workpiece and the second workpiece.

9. A method as claimed in claim 1 wherein, the nanoparticles have a diameter of between 20 and 60 nm.

10. A method as claimed in claim 1 wherein, the nanoparticles are silver nanoparticles.

11. A method as claimed in claim 1 wherein, the step of positioning the first and second work pieces in operative contact comprises applying a pressure to ensure operative contact between the first and second workpieces at the interface.

12. (canceled)

13. A method as claimed in claim 1 wherein, the Interface comprises the region upon the second work piece upon which the laser beam is incident for the purpose of forming a weld wherein, the first workpiece is substantially transparent to the laser beam and the laser beam is transmitted through the first work piece to the interface.

14. (canceled)

15. (canceled)

16. A method as claimed in claim 1 wherein, the laser is a nanosecond pulsed laser.

17. A method as claimed in claim 1 wherein, the laser has a pulse length of between 1 ns and 100 ns.

18. A method as claimed in claim 1 wherein, the laser has a repetition rate of between 20 kHz and 200 kHz.

19. (canceled)

20. (canceled)

21. A method as claimed in claim 1 wherein, the laser has a wavelength of 532 nm.

22. A method as claimed in claim 1 wherein, the laser beam had a Gaussian intensity profile and the ratio of the beam parameter product (BPP) of an actual beam to that of an ideal Gaussian beam at the same wavelength is approximately ≦1.3 (M²).

23. (canceled)

24. A method as claimed in claim 1 wherein, the laser beam focussed upon the interface has a flat surface which is achieved using a flat field scanning lens system.

25. (canceled)

26. A method as claimed in claim 1 wherein, the laser beam applied to the interface is a focussed spot with a diameter of between 0.5 μm and 300 μm where the intensity of the spot has fallen to 1/e² of the central value.

27. A method as claimed in claim 26 wherein, said diameter is 60 μm.

28. A method as claimed in claim 1 wherein, the laser operates with a mean laser fluence of from 0.05 to 3 J/cm².

29. (canceled)

30. (canceled)

31. (canceled)

32. (canceled)

33. A method as claimed in claim 1 wherein, the second workpiece is an ion exchange product.

34. A method as claimed in claim 33 wherein, the method of the present invention comprises irradiating the ion exchange product with a first laser beam to create one or more regions of metal nanoparticles, then welding the second workpiece to the first workpiece using a second laser beam.

35. A method as claimed in claim 33 wherein, the first laser beam has a wavelength of 355 nm and the second laser beam has a wavelength of 532 nm.

36. (canceled)

37. (canceled)

38. (canceled)

39. (canceled)

40. A glass product comprising a first workpiece in operative contact with a second workpiece at an interface and a weld joining the first workpiece to the second workpiece at the interface;
wherein the second workpiece comprises metal nanoparticles at or near the surface of the second workpiece, wherein the metal nanoparticles are integrally formed with the second workpiece and absorb the energy from a laser beam then transfer the absorbed energy to the glass surrounding the metal nanoparticles to heat the glass of the second workpiece and to weld it to the first workpiece.

41. A glass product as claimed in claim 40 wherein, the metal nanoparticles are distributed substantially homogeneously across a layer or region of the second work piece.

42. A glass product as claimed in claim 40 wherein, the layer or region is a predetermined depth below the interface.

43. A glass product as claimed in claim 40 wherein, the metal nanoparticles directly absorb the energy from the laser beam then transfer the absorbed energy to the glass surrounding the metal nanoparticles to heat the glass of the second workpiece and to weld it to the first workpiece.

44. A glass product as claimed in claim 40 wherein, the nanoparticles are arranged in a layer.

45. A glass product as claimed in claim 44 wherein, the layer of nanoparticles has a thickness of between 500 nm and 50 μm.

46. A glass product as claimed in claim 44 wherein, the nanoparticles are positioned around 30 nanometres beneath the surface of the second workpiece.

47. A glass product as claimed in claim 44 wherein, the transfer of absorbed energy from the metal nanoparticles to the glass causes an expansion of the nanoparticle containing layer which facilitates the weld between the first workpiece and the second workpiece.

48. A glass product as claimed in claim 44 wherein, the nanoparticles have a diameter of between 20 and 60 nm.

49. A glass product as claimed in claim 44 wherein, the nanoparticles are silver nanoparticles.

50. A glass product as claimed in claim 40 wherein, the Interface comprises the region upon the second work piece upon which the laser beam is incident for the purpose of forming a weld.

51. A glass product as claimed in claim 40 wherein, the first workpiece is substantially transparent to the laser beam.

52. (canceled)

53. (canceled)

54. (canceled)

55. (canceled)

56. A glass product as claimed in claim 44 wherein the joint strength between the first and second workpieces is between 10 and 15 MPa.

57. A glass product as claimed in claim 44 wherein, the first glass workpiece comprises metal nanoparticles at or near the surface thereof.

58. A glass product as claimed in claim 57 wherein, the metal nanoparticles are located at the interface where the weld is to be formed.
